(19) United States
(12) Patent Application Publication
(10) Pub. No.: US 2001/0040079 A1
(43) Pub. Date: Nov. 15, 2001

(54) APPARATUS FOR REDUCING HARMONICS AND VIBRATIONS OF A ROTATING BASE PIECE

(75) Inventor: KENNETH TUROS, ALBUQUERQUE, NM (US)

Correspondence Address: RAY R REGAN, P O BOX 1442, CORRALES, NM, 87048

(73) Assignee: Ray R. Regan, Esq.

(21) Appl. No.: 09/249,514

(22) Filed: Feb. 12, 1999

(51) Int. Cl. F16F 7/10

(52) U.S. Cl. 188/378

(57) ABSTRACT

An apparatus for reducing harmonics and vibrations of a rotating base piece. The apparatus includes a plurality of chain links. The plurality of chain links are interconnected to form a belt assembly open at the ends. The belt assembly has a leading end and a following end. The chain links are interconnected between the leading end and the following end. An apparatus for reducing harmonics and vibrations of a rotating base piece also includes a spring member. The spring member is connectable to the leading end and the following end of the belt. The belt may be attached to a rotating base piece for reducing harmonics and vibrations of a rotating base piece during rotation of the rotating base piece.

### CROSS-REFERENCE TO RELATED APPLICATION

None.

### FEDERALLY SPONSORED RESEARCH AND DEVELOPMENT

None.

### FIELD OF THE INVENTION

The present invention pertains generally to reducing harmonics and vibrations of a rotating base piece during operation of a machine. More particularly, the present invention pertains to an apparatus for reducing harmonics and vibrations of a rotating rotor removably attached to a rotating machine member. The present invention is particularly, but not exclusively, useful for reducing harmonics and vibrations of a brake rotor attached to a rotating machine member during a turning procedure.

### BACKGROUND OF THE INVENTION

Gravity, friction, velocity of rotation, and load forces are applied during operation to bearings, drive shafts, driven shafts, turning spindles, rotors, retaining devices, and other components of driving and driven machines (collectively, “machine members”). Circular rotation of shafts mounted in bearings gives rise to centripetal force, a force that is reacted to by centrifugal reaction. Angular velocity and angular acceleration of rotating base pieces subjected not only to certain velocities, but also to loads or pressure, also may induce gyroscopic effects on rotating base pieces that are attached to a rotating machine member turning or rotating rapidly. Machine members, and base pieces attached to machine members, also may be subjected to significant loads about the geometric and rotational axes of a rotating base piece. As is commonly known, when two forces act on a shaft, spindle, pin, axle or similar rod or assembly (collectively, “shaft”), a torque may be formed whose vector along an x-axis may produce a rotation about the y-axis known as precession. Such rotation may generate significant angular velocities. These forces, phenomena, torque and related effects may individually and collectively contribute to inducing nonuniform rotation of a base piece that has been attached to a rotating shaft.

In connection with a rotating machine member in which angular accelerations and velocities are present, unbalanced forces may lead to high harmonics and vibrations. Further, in some, but not all instances, if the speed of rotation of a shaft is slowly increased from rest, a speed may be achieved at which a deflection increases suddenly, a phenomenon known as “whirling.” A shaft that is balanced will rotate around the center of gravity or axis of rotation of a shaft. If a shaft rotates at an angular velocity, however, the shaft may deflect a distance from the center of gravity or axis of rotation due to centripetal reaction. Rotation also may induce undamped free vibrations. All of these forces and phenomena, and others, may contribute to nonuniform rotation of the shaft, and consequent nonuniform rotation of a base piece attached to a machine member mounted on the shaft. This is particularly true, but not exclusively, in machine members on which brake rotors are mounted for turning purposes, such as refinishing or resurfacing the brake rotor. A machine used to refinish or resurface a brake rotor generally includes a driving motor, a driven or turning shaft, one or more retaining devices attached to the shaft for removably mounting a base piece such as a brake rotor on the one or more retaining devices, and one or more cutting tools that may reciprocally engage a surface of a brake rotor to be refinished or resurfaced.

During refinishing or resurfacing of a base piece such as a brake rotor, the forces and phenomena described above may cause harmonics and vibrations that are transmitted to the brake rotor during rotation. Any nonuniform rotation of the brake rotor during operation may cause a cutting tool to produce an inferior refinished or resurfaced surface. While numerous apparatus have been suggested to attempt to reduce harmonics and vibrations in a rotating base piece such as a brake rotor, none has proven entirely successful, and none has proven as useful and inexpensive as the present invention.

The problem to be solved, therefore, is reduction of harmonics and vibrations of a rotating base piece that is removably attached to a rotating machine member during operation of a machine. Further, what is needed is an apparatus for reducing harmonics and vibrations of a rotating brake rotor, whether vented or unvented, that is useful for producing a more precisely turned and resurfaced brake rotor.

One of the advantages of the novel apparatus for reducing harmonics and vibrations of a rotating base piece, according to the present invention, is that the apparatus for reducing harmonics and vibrations of a rotating base piece produces a more precisely turned and resurfaced brake rotor. Another advantage of the present invention is an apparatus for reducing harmonics and vibrations of a rotating base piece that dampens noises and vibrations during operation of the machine on which the rotating base piece is removably attached. The present invention also has the advantage simplicity.

Yet another advantage of the present invention is to provide a new and improved apparatus for reducing harmonics and vibrations of a rotating base piece, such as a brake rotor, that may be easily and efficiently manufactured. Another advantage of the present invention is its durability and reliable construction. An even further advantage of an apparatus for reducing harmonics and vibrations of a rotating base piece, according to the present invention, is its low cost of manufacture with regard to both materials and labor. Thus, another advantage of the present invention is a apparatus for reducing harmonics and vibrations of a rotating base piece and a method for reducing harmonics and vibrations of a rotating base piece which respectively are easy to use and to practice, and which are cost effective for their intended purposes.

These advantages and other objects and features of such apparatus for reducing harmonics and vibrations of a rotating base piece will become apparent to those skilled in the art when read in conjunction with the accompanying following detailed description, drawing figures, and appended claims.

### SUMMARY OF THE INVENTION

An apparatus for reducing harmonics and vibrations of a rotating base piece, according to the present invention, includes a plurality of chain links. The plurality of chain links are interconnected to form a belt assembly the two ends of which are not interconnected. The belt assembly has a leading end and a following end. The chain links are interconnected between the leading end and the following end. An apparatus for reducing harmonics and vibrations of a rotating base piece also includes a spring member. The spring member is connectable to the leading end and the following end of the belt. The spring member assists in mounting the belt assembly to a rotating base piece. The belt assembly, for example, may be attached to a rotatable brake rotor for reducing harmonics and vibrations of a rotating base piece during rotation of the brake rotor.

The foregoing has outlined broadly the more important features of the invention to better understand the detailed description that follows, and to better understand the contribution of the present invention to the art. Before explaining at least one embodiment of the invention in detail, it is to be understood that the invention is not limited in application to the details of construction, and to the arrangements of the components, provided in the following description or drawing figures. The invention is capable of other embodiments, and of being practiced and carried out in various ways. Also, the phraseology and terminology employed in this disclosure are for purpose of descriptions and should not be regarded as limiting.

As those skilled in the art will appreciate, the conception on which this disclosure is based may be readily used as a basis for designing other structures, cooperation of structure, methods, and systems for carrying out the purposes of the present invention. The claims, therefore, include such equivalent constructions to the extent the equivalent constructions do not depart from the spirit and scope of the present invention.

The abstract associated with this disclosure is neither intended to define the invention, which is measured by the claims, nor intended to be limiting as to the scope of the invention in any way.

The novel features of this invention, and the invention itself, both as to structure and operation, are best understood from the accompanying drawing, considered in connection with the accompanying description of the drawing, in which similar reference characters refer to similar parts, and in which:

### BRIEF DESCRIPTION OF THE DRAWING

FIG. 1 is a perspective or isometric view of the apparatus for reducing harmonics and vibrations of a rotating base piece; and

FIG. 2 is a perspective view of a representative machine, not claimed in the present invention, having a machine member to which a base piece may be removably mounted.

### DESCRIPTION OF THE PREFERRED EMBODIMENTS

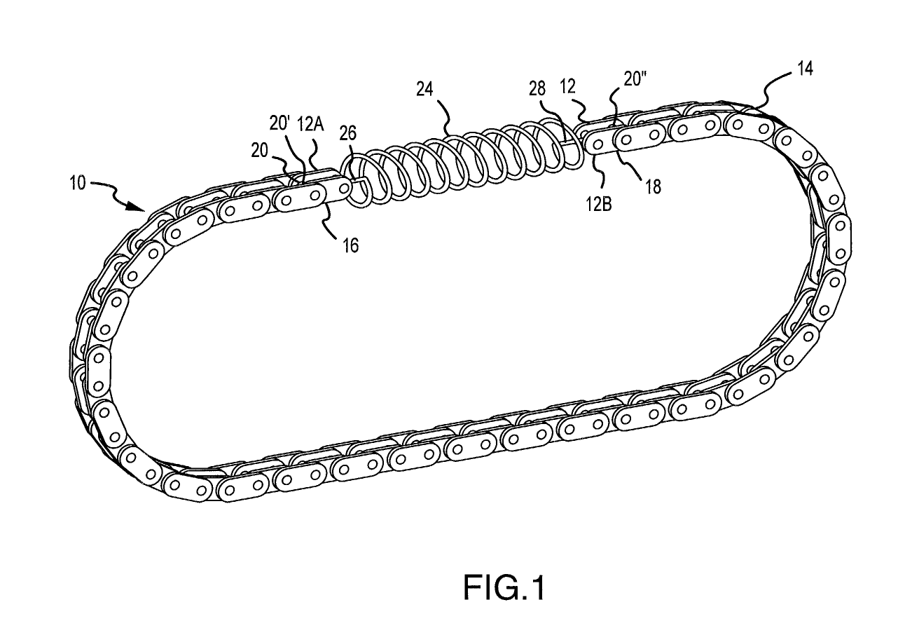

Referring initially to FIG. 1, the apparatus for reducing harmonics and vibrations of a rotating base piece is shown and generally designated 10. As shown, an apparatus for reducing harmonics and vibrations of a rotating base piece 10 includes a plurality of chain links 12. Plurality of chain links 12 are interconnected to form a belt assembly 14. Belt assembly 14 has a leading end 16 and a following end 18. Leading end 16 and following end 18 are not interconnected with each other. Chain links 12 are interconnected between leading end 16 and following end 18.

As also shown in FIG. 1, an apparatus for reducing harmonics and vibrations of a rotating base piece 10, also includes means for releasing each of the plurality of chain links 12 from a trailing chain link 12A or a following chain link 12B, and from belt assembly 14. In the preferred embodiment of the present invention, the means for releasing each of the plurality of chain links 12 from a trailing chain link 12A or a following chain link 12B, and from belt assembly 14 is a releasable rod 20. In the preferred embodiment of the present invention, chain links 12 are made of metal. In an alternative embodiment of the present invention each of the plurality of chain links 12 may be made of a resin material.

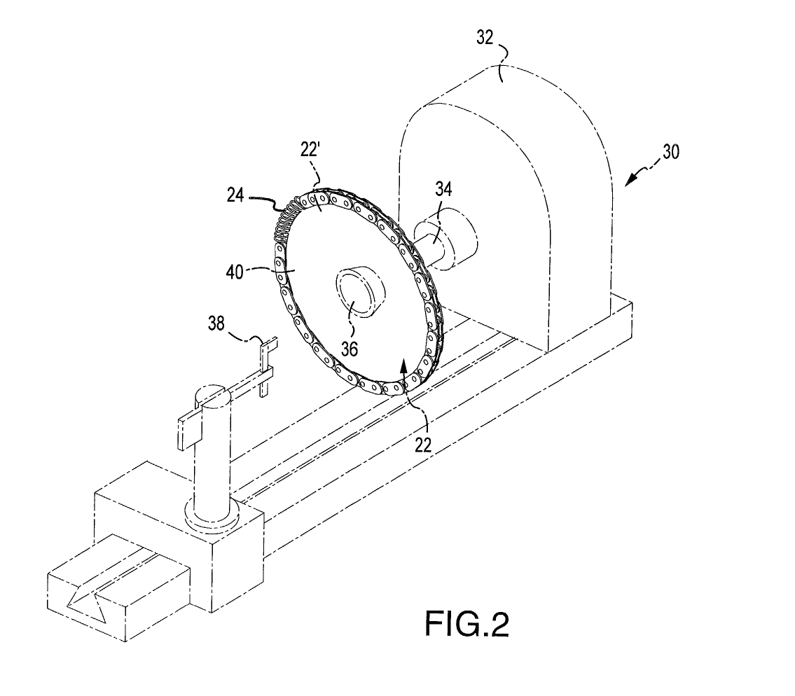

As shown best by cross-reference between FIGS. 1 and 2, an apparatus for reducing harmonics and vibrations of a rotating base piece, according to the present invention, also includes means for attaching belt assembly 14 to base piece 22. In the preferred embodiment of the present invention, the attaching means is a spring member 24. Spring member 24 is formed with a first end 26 and a second end 28. In the preferred embodiment of the present invention, first end 26 and second end 28 are curved to facilitate engagement of first end 26 and second end 28 with a rod 20′ and rod 20″. First end 26 of spring member 24 is engageable with leading end 16 of belt assembly 14, and second end 28 of spring member 24 is engageable with following end 18 of belt assembly 14.

Referring now to FIG. 2, in the preferred embodiment of the present invention base piece 22 is a brake rotor 22′. A machine 30 used to refinish or resurface a brake rotor 22′ generally includes a driving motor 32, a driven or turning shaft 34, one or more retaining devices 36 attached to shaft 34 for removably mounting base piece 22, such as brake rotor 22′ on one or more retaining devices 36, and a cutting tool 38 that may reciprocally engage a surface 40 of brake rotor 22′ to be refinished or resurfaced.

During refinishing or resurfacing of base piece 22, such as a brake rotor 22′, forces and phenomena described in this disclosure may cause harmonics and vibrations that are transmitted to brake rotor 22′ during rotation of shaft 34. Lacking the dampening effect of the apparatus for reducing harmonics and vibrations of a rotating base piece 10, according to the present invention, nonuniform rotation of brake rotor 22′ during rotation of shaft 34 would cause cutting tool 38 to produce an inferior refinished or resurfaced surface 40 on composite brake rotors 22′ and a variety of hubless brake rotors 22′.

In the preferred embodiment of the present invention, each of the plurality of chain links 12 may be of varying lengths and sizes. Uniformity of shape and dimension of each of the plurality of chain links 12 is not a requirement or limitation of the present invention. The individual chain links 12 included in belt assembly 14 are not stretchable, or formed of deformable or elastomeric material. In addition, a remarkable feature of the present invention is the absence of any other element or component of the invention. No additional element or component, other than those disclosed in this document, needs to be added to, or incorporated with, the apparatus for reducing harmonics and vibrations of a rotating base piece to achieve the advantages of the present invention. In alternative embodiments of the present invention, however, the dimensions of chain links 12 and spring member 24 may vary, so that the dimensions of belt assembly 14 may vary.

While the apparatus for reducing harmonics and vibrations of a rotating base piece shown in the drawing figures is one embodiment of the present invention, it is merely one embodiment of the invention, is not intended to be exclusive, and is not a limitation of the present invention.

The particular apparatus for reducing harmonics and vibrations of a rotating base piece as shown and disclosed in detail in this instrument is fully capable of obtaining the objects and providing the advantages stated, but this disclosure is merely illustrative of the presently preferred embodiments of the invention, and no limitations are intended in connection with the details of construction, design or composition other than as provided and described in the appended claims.

What is claimed is:

1. An apparatus for reducing harmonics and vibrations of a rotating base piece, comprising:
a plurality of chain links forming a belt assembly having a leading end and a following end, wherein the chain links are interconnected between the leading end and the following end; and
means for demountably attaching the belt assembly to a rotating base piece.

2. An apparatus for reducing harmonics and vibrations of a rotating base piece as recited in claim 1, wherein each of the plurality of chain links further comprises means for releasing each of the plurality of chain links from the belt.

3. An apparatus for reducing harmonics and vibrations of a rotating base piece as recited in claim 2, wherein the releasing means is a rod.

4. An apparatus for reducing harmonics and vibrations of a rotating base piece as recited in claim 3, wherein each of the plurality of chain links is made of metal.

5. An apparatus for reducing harmonics and vibrations of a rotating base piece as recited in claim 3, wherein each of the plurality of chain links is made of a resin material.

6. An apparatus for reducing harmonics and vibrations of a rotating base piece as recited in claim 3, wherein the attaching means is a spring member .

7. An apparatus for reducing harmonics and vibrations of a rotating base piece as recited in claim 6, wherein the rotating base piece is a rotor.

8. An apparatus for reducing harmonics and vibrations of a rotating base piece as recited in claim 6, wherein the rotating base piece is a brake rotor.

9. An apparatus for reducing harmonics and vibrations of a rotating base piece as recited in claim 6, wherein the spring member further comprises a first end and a second end.

10. An apparatus for reducing harmonics and vibrations of a rotating base piece as recited in claim 9, wherein the first end of the spring member is engageable with the leading end of the belt, and the second end of the spring member is engageable with the following end of the belt.

11. An apparatus for reducing harmonics and vibrations of a rotating base piece removably attachable to a rotating machine member, comprising:
a plurality of chain links forming a belt assembly having a leading end and a following end, wherein the chain links are interconnected between the leading end and the following end; and
a spring member connectable to the leading end and the following end for demountably attaching the belt assembly to a rotating base piece.

12. An apparatus for reducing harmonics and vibrations of a rotating base piece removably attachable to a rotating machine member as recited in claim 11, wherein each of the plurality of chain links further comprises means for releasing each of the plurality of chain links from the belt.

13. An apparatus for reducing harmonics and vibrations of a rotating base piece removably attachable to a rotating machine member as recited in claim 12, wherein the releasing means is a releasable rod.

14. An apparatus for reducing harmonics and vibrations of a rotating base piece removably attachable to a rotating machine member as recited in claim 13, wherein each of the plurality of chain links is made of metal.

15. An apparatus for reducing harmonics and vibrations of a rotating base piece removably attachable to a rotating machine member as recited in claim 13, wherein each of the plurality of chain links is made of a resin material.

16. An apparatus for reducing harmonics and vibrations of a rotating base piece removably attachable to a rotating machine member as recited in claim 13, wherein the rotating base piece is a rotor.

17. An apparatus for reducing harmonics and vibrations of a rotating base piece removably attachable to a rotating machine member as recited in claim 16, wherein the rotating base piece is a brake rotor.

18. An apparatus for reducing harmonics and vibrations of a rotating base piece removably attachable to a rotating machine member as recited in claim 17, wherein the spring member further comprises a first end and a second end, and wherein the first end and second end may be attached to either end of the belt.

19. A method for manufacturing an apparatus for reducing harmonics and vibrations of a rotating base piece, comprising the steps of:
interconnecting a plurality of chain links forming a belt having a leading end and a following end, wherein the chain links are interconnected between the leading end and the following end; and
providing means for demountably attaching the belt to a rotating base piece.

20. A method for manufacturing an apparatus for reducing harmonics and vibrations of a rotating base piece as recited in claim 19, wherein the providing means is a spring member.
